(19) United States
(12) Patent Application Publication
(10) Pub. No.: US 2025/0348355 A1
(43) Pub. Date: Nov. 13, 2025

(54) AUTOMATED ON-DEMAND OCCUPANT ENVIRONMENT MODULATION IN A DATA CENTER

(71) Applicant: INTERNATIONAL BUSINESS MACHINES CORPORATION, Armonk, NY (US)

(72) Inventors: Khaalid Persaud Juggan MCMILLAN, Haverstraw, NY (US); Suraush KHAMBATI, Poughkeepsie, NY (US); Noah SINGER, White Plains, NY (US); Ryan ELSASSER, Salt Point, NY (US); Dustin DEMETRIOU, Hyde Park, NY (US); Milnes P. DAVID, New Paltz, NY (US); Allan Cory VANDEVENTER, Poughkeepsie, NY (US); Felipe Andres VALENZUELA GAETE, Poughkeepsie, NY (US); Seth Elijah BARD, Poughkeepsie, NY (US); Yuanchen HU, Peekskill, NY (US); Brandon M. KOBILKA, Fishkill, NY (US); Camillo SASSANO, Durham, NC (US); Shawn DEUTCHMAN, Poughkeepsie, NY (US)

(21) Appl. No.: 18/660,429

(22) Filed: May 10, 2024

(51) Int. Cl. G06F 9/48

(52) U.S. Cl. CPC G06F 9/4893

(57) ABSTRACT

Automated on-demand occupant environment modulation in a data center, including: identifying, by a computing device operatively coupled to one or more computing devices in a data center, based on data from one or more sensors, a location of an individual in the data center; and modifying, by the computing device, one or more environmental parameters at the location, including modifying operation of the one or more computing devices in the data center based on the location of the individual in the data center relative to the one or more computing devices.

### BACKGROUND

The present disclosure relates to methods, apparatus, and products for automated on-demand occupant environment modulation in a data center. Data centers house many mainframes or servers with varying workloads in large climate-controlled rooms. As workload volume changes across the data center, this may affect various operational parameters including the ambient temperature, the contact temperature of components, and the noise level in the data center. While there is an incentive to run data centers warmer and at higher utilization rates to maximize the output of the servers over their lifecycle and reduce cooling costs, this may negatively impact the environmental parameters as experienced by individuals in the data center. Moreover, various policies or regulatory requirements may set guidelines for working conditions with respect to these environmental parameters that may run contrary to this incentive.

### SUMMARY

According to embodiments of the present disclosure, various methods, apparatus and products for automated on-demand occupant environment modulation in a data center are described herein. In some aspects, automated on-demand occupant environment modulation in a data center includes identifying, by a computing device operatively coupled to one or more computing devices in a data center, based on data from one or more sensors, a location of an individual in the data center; and modifying, by the computing device, one or more environmental parameters at the location, including modifying operation of the one or more computing devices in the data center based on the location of the individual in the data center relative to the one or more computing devices. In some aspects, an apparatus may include a processing device; and memory operatively coupled to the processing device, wherein the memory stores computer program instructions that, when executed, cause the processing device to perform this method. In some aspects, a computer program product comprising a computer readable storage medium may store computer program instructions that, when executed, perform this method.

### BRIEF DESCRIPTION OF THE DRAWINGS

FIG. 1 sets forth a block diagram of an example computing environment for automated on-demand occupant environment modulation in a data center in accordance with some embodiments of the present disclosure.

FIG. 2 sets forth a flowchart of an example method of automated on-demand occupant environment modulation in a data center in accordance with some embodiments of the present disclosure.

FIG. 3 sets forth a flowchart of another example method of automated on-demand occupant environment modulation in a data center in accordance with some embodiments of the present disclosure.

FIG. 4 sets forth a flowchart of another example method of automated on-demand occupant environment modulation in a data center in accordance with some embodiments of the present disclosure.

FIG. 5 sets forth a flowchart of another example method of automated on-demand occupant environment modulation in a data center in accordance with some embodiments of the present disclosure.

FIG. 6 sets forth a flowchart of another example method of automated on-demand occupant environment modulation in a data center in accordance with some embodiments of the present disclosure.

### DETAILED DESCRIPTION

In some aspects, automated on-demand occupant environment modulation in a data center includes identifying, by a computing device operatively coupled to one or more computing devices in a data center, based on data from one or more sensors, a location of an individual in the data center; and modifying, by the computing device, one or more environmental parameters at the location, including modifying operation of the one or more computing devices in the data center based on the location of the individual in the data center relative to the one or more computing devices. This provides the advantage of allowing for modulation of environmental parameters relative to the location of the individual, ensuring optimal working conditions for the individual while maintaining safety and sustainability goals.

In some aspects, the one or more environmental parameters comprise a wet bulb global temperature (WBGT) for the individual. This provides the advantage of allowing for the temperature relative to an individual to be adjusted by modifying operation of the computing devices.

In some aspects, the one or more environmental parameters comprise a contact temperature for the one or more computing devices. This provides the advantage of allowing for the contact temperature of components an individual may touch to be adjusted by modifying operation of the computing devices.

In some aspects, modifying the operation of the one or more computing devices in the data center includes redistributing one or more workloads across the one or more computing devices. This provides the advantage of workloads for computing devices proximate to the individual to be reduced, thereby reducing their overall heat output.

In some aspects, modifying the operation of the one or more computing devices in the data center includes modifying a fan speed of the one or more computing devices in the data center. This provides the advantage of modulating fan speeds on computing devices proximate to an individual to increase cool air flow or reduce noise experienced by the individual.

In some aspects, modifying the one or more environmental parameters further comprises modifying operation of one or more computer room air conditioning (CRAC) units based on the location of the individual. This provides the advantage of further environmental control by modifying operation of the CRAC units.

In some aspects, the one or more environmental parameters comprise a noise level. This provides the advantage of allowing for noise levels to be adjusted to improve comfort and safety of the individual.

In some aspects, this method also includes providing a visual indicator to a device associated with the individual based on a degree to which one or more environmental parameter targets are met. This provides the advantage of providing information to an individual about the environmental parameters they are experiencing.

In some aspects, the device facilitates measuring the one or more environmental parameters. This provides the advantage of having a single device that provides both information about the environment and sensors to assist in measuring the environmental parameters. In some aspects, the device facilitates identifying the location of the individual. This provides the advantage of having a single device that provides both information about the environment and sensors to assist in locating the individual.

In some aspects, this method also includes: identifying another location in the data center associated with the individual; and modifying the one or more environmental parameters at the other location, including modifying operation of one or more computing devices in the data center based on the other location relative to the one or more computing devices. This provides the advantage of allowing for continual modulation of environmental parameters as the actual or predicted location of the individual changes over time.

In some aspects, the other location comprises an updated location of the individual. This provides the advantage of allowing for environmental parameters to be modified as the location of an individual changes over time.

In some aspects, the other location comprises a predicted location of the individual. This provides the advantage of allowing for environmental parameters to be modified based on where the individual is predicted to be.

In some aspects, this method includes providing a recommended work duration at the location. This provides the advantage of informing an individual as to safe durations for performing work under particular circumstances.

In some aspects, an apparatus for automated on-demand occupant environment modulation in a data center includes a processing device; and memory operatively coupled to the processing device, wherein the memory stores computer program instructions that, when executed, cause the processing device to: identifying, based on data from one or more sensors, a location of an individual in the data center; and modify one or more environmental parameters at the location, wherein, to modify the one or more environmental parameters, the instructions further cause the processing device to modify operation of one or more computing devices in the data center based on the location of the individual in the data center relative to the one or more computing devices. This provides the advantage of allowing for modulation of environmental parameters relative to the location of the individual, ensuring optimal working conditions for the individual while maintaining safety and sustainability goals.

In some aspects, the one or more environmental parameters comprise a wet bulb global temperature (WBGT) for the individual. This provides the advantage of allowing for the temperature relative to an individual to be adjusted by modifying operation of the computing devices.

In some aspects, the one or more environmental parameters comprise a contact temperature for the one or more computing devices. This provides the advantage of allowing for the contact temperature of components an individual may touch to be adjusted by modifying operation of the computing devices.

In some aspects, to modify the operation of the one or more computing devices in the data center, the computer program instructions, when executed, further cause the processing device to redistribute one or more workloads across the one or more computing devices. This provides the advantage of workloads for computing devices proximate to the individual to be reduced, thereby reducing their overall heat output.

In some aspects, to modify the operation of the one or more computing devices in the data center, the computer program instructions, when executed, further cause the processing device to modify a fan speed of the one or more computing devices in the data center. This provides the advantage of modulating fan speeds on computing devices proximate to an individual to increase cool air flow or reduce noise experienced by the individual.

In some aspects, wherein, to modify the one or more environmental parameters, the instructions, when executed, further cause the processing device to modify operation of one or more computer room air conditioning (CRAC) units based on the location of the individual. This provides the advantage of further environmental control by modifying operation of the CRAC units.

In some aspects, the one or more environmental parameters comprise a noise level. This provides the advantage of allowing for noise levels to be adjusted to improve comfort and safety of the individual.

In some aspects, the computer program instructions, when executed, further cause the processing device to provide a visual indicator to a device associated with the individual based on a degree to which one or more environmental parameter targets are met. This provides the advantage of providing information to an individual about the environmental parameters they are experiencing.

In some aspects, the device facilitates measuring the one or more environmental parameters. This provides the advantage of having a single device that provides both information about the environment and sensors to assist in measuring the environmental parameters. In some aspects, the device facilitates identifying the location of the individual. This provides the advantage of having a single device that provides both information about the environment and sensors to assist in locating the individual.

In some aspects, wherein the computer program instructions, when executed, further cause the processing device to: identifying, by a computing device operatively coupled to one or more computing devices in a data center, based on data from one or more sensors, a location of an individual in the data center; and modify one or more environmental parameters at the location, wherein, to modify the one or more environmental parameters, the instructions further cause the processing device to modify operation of one or more computing devices in the data center based on the location of the individual in the data center relative to the one or more computing devices. This provides the advantage of allowing for continual modulation of environmental parameters as the actual or predicted location of the individual changes over time.

In some aspects, the other location comprises an updated location of the individual. This provides the advantage of allowing for environmental parameters to be modified as the location of an individual changes over time.

In some aspects, a computer program product for automated on-demand occupant environment modulation in a data center includes a computer readable storage medium storing computer program instructions that, when executed: identifying, by a computing device operatively coupled to one or more computing devices in a data center, based on data from one or more sensors, a location of an individual in the data center; and modify one or more environmental parameters at the location, wherein, to modify the one or more environmental parameters, the instructions further cause the processing device to modify operation of one or more computing devices in the data center based on the location of the individual in the data center relative to the one or more computing devices.

Data centers house many mainframes or servers with varying workloads in large climate-controlled rooms. As workload volume changes across the data center, this may affect various operational parameters including the ambient temperature, the contact temperature of components, and the noise level in the data center. While there is an incentive to run data centers warmer and at higher utilization rates to maximize the output of the servers over their lifecycle and reduce cooling costs, this may negatively impact the environmental parameters as experienced by individuals in the data center. Moreover, various policies or regulatory requirements may set guidelines for working conditions with respect to these environmental parameters that may run contrary to this incentive. For example, a data center running warm to reduce cooling costs may result in ambient or contact temperatures above limits set by regulatory agencies.

Though the data center may increase the overall amount of cooling so as to reduce these ambient or contact temperatures, this increases the energy usage of the data center which may conflict with economic or sustainability goals. Moreover, this may result in greater noise levels, further negatively impacting the working conditions in the data center.

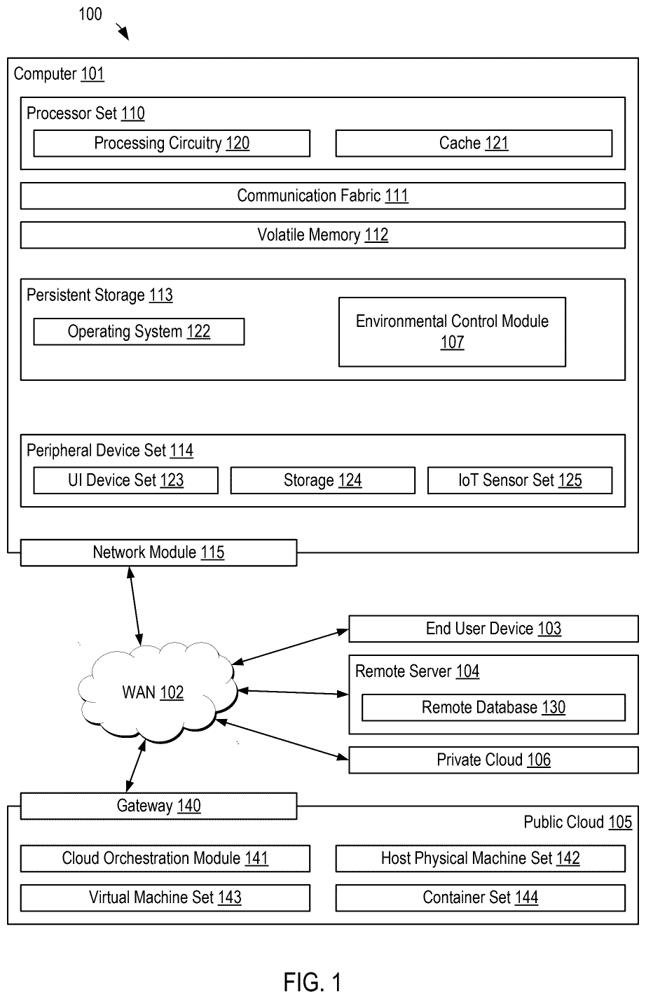

With reference now to FIG. 1, shown is an example computing environment according to aspects of the present disclosure. Computing environment 100 contains an example of an environment for the execution of at least some of the computer code involved in performing the various methods described herein, such as the environmental control module 107. In addition to the environmental control module 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

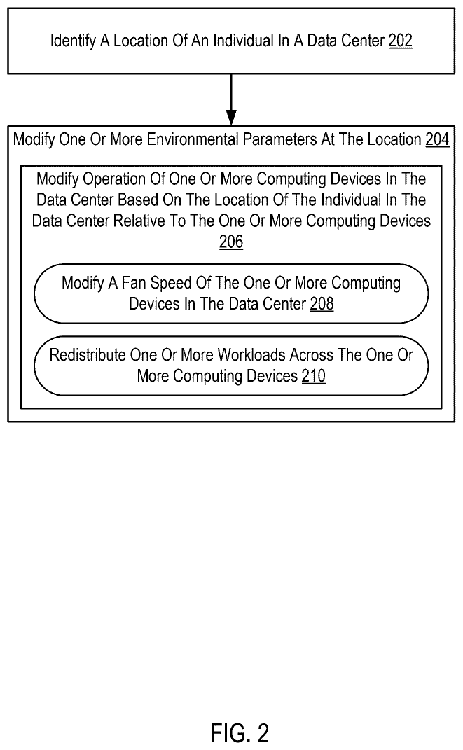

For further explanation, FIG. 2 sets forth a flowchart of an example method of automated on-demand occupant environment modulation in a data center in accordance with some embodiments of the present disclosure. The method of FIG. 2 may be performed, for example, by the environmental control module 107 of FIG. 1. The method of FIG. 2 includes identifying 202 a location of an individual in a data center. As described herein, a data center may include a dedicated room or environment housing multiple operational computing devices, such as multiple racks of servers. In some embodiments, the location of the individual in a data center may be expressed using a set of coordinates in a two-dimensional or three-dimensional space of the data center. In some embodiments, the location of the individual in a data center may be expressed as a particular computing device or collection of computing devices (e.g., a particular rack) most proximate to the individual. For example, in some embodiments, the location of the individual may be expressed as a particular row and/or a particular rack on the particular row to which the individual is most proximate. In some embodiments, the location of the individual in the data center may be expressed using other approaches.

Identifying 202 the location of the individual in the data center may be performed using a variety of approaches. In some embodiments, video data or image data capturing the individual in the data center may be used to identify 202 the location of the individual. In some embodiments, a global positioning system (GPS) sensor or other location-identifying sensor on a device associated with the individual (e.g., in possession of the individual) may provide a signal indicating the location of the individual in the data center. In some embodiments, a signal from such a device, such as a Bluetooth or Radio Frequency Identification (RFID) signal, may be used to identify 202 the location of the individual. For example, the location of the individual may be identified 202 based on the location of a nearest receiver of such a signal, by triangulating the signal strength of such a signal from multiple receivers, and the like. In embodiments where a signal from a device associated with the individual is used to identify 202 the location of the individual, such devices may include mobile computing devices such as smart phones, tablets, or laptops, or may include other devices such as wearable sensors including wearable temperature sensors, wearable decibel meters, and the like. In some embodiments, one or more proximity sensors in the data center may be used to identify 202 the location of the individual in the data center. Other approaches may also be used to identify 202 the location of the individual in the data center.

In some embodiments, the location of the individual may be used to identify one or more computing devices in the data center that may be serviced by the individual. For example, in some embodiments, the computing device or rack nearest the individual may be assumed to be subject to service by the individual. In some embodiments, one or more trained models, designated service schedules, and the like may be used to determine whether an individual is proximate to a particular device or rack due to walking past or other incidental activity rather than to service the particular device or rack.

The method of FIG. 2 also includes modifying 204 one or more environmental parameters at the location. In some embodiments, the one or more environmental parameters may include a temperature. For example, the one or more environmental parameters may include a wet bulb global temperature (WBGT) or other temperature measurement describing the temperature of the environment around the individual at the location. As another example, in some embodiments, the one or more environmental parameters may include a contact temperature describing a surface temperature of one or more computing devices at the location (e.g., of one or more computing devices proximate to the location of the individual in the data center). Accordingly, in some embodiments, modifying 204 the one or more environmental parameters at the location may include lowering the WBGT and/or the contact temperature. In some embodiments, the one or more environmental parameters may include a noise level (e.g., an acoustic volume in decibels) experienced at the location. Accordingly, in some embodiments, modifying 204 the one or more environmental parameters at the location may include lowering the noise level at the location. The one or more environmental parameters may also include other environmental parameters as can be appreciated.

In order to modify 204 the one or more environmental parameters at the location, the operation of one or more computing devices in the data center are modified. Accordingly, in some embodiments, modifying 204 the one or more environmental parameters includes modifying 206 operation of one or more computing devices in the data center based on the location of the individual in the data center relative to the one or more computing devices. For example, in some embodiments, operation of one or more computing devices most proximate to the location of the individual (e.g., and potentially other computing devices) may be modified 206 so as to modify 204 the one or more environmental parameters at the location. The particular approaches for modifying 206 operation of the one or more computing devices may vary depending on the particular environmental parameters to be modified.

In some embodiments, modifying 206 operation of the one or more computing devices may include modifying 208 a fan speed of the one or more computing devices in the data center. As an example, in order to reduce the contact temperature of a particular computing device or rack of computing devices, the fan speed in those devices may be increased to increase cooling and thereby reduce the contact temperature of the rear of the devices where service may occur. In this example, the fan speed of the device(s) closest to the individual may be increased as it may be assumed that the individual is going to service these devices, thereby necessitating that the contact temperature be dropped. As another example, assume that the individual is in the hot aisle of a data center. In order to reduce the WBGT at the location, fan speed at one or more computing devices near the individual may be increased to increase cool airflow from a cold aisle of the data center to the hot aisle where service will occur. Continuing with this example, fan speed at the nearest device or rack as well as at other devices or racks (e.g., in the same row, sharing the same hot aisle) so as to increase overall cool air flow into the hot aisle where the individual is located.

In some embodiments, modifying 208 the fan speed of the one or more computing devices may include reducing the fan speed of one or more of the computing devices. As an example, while increasing the fan speed of some devices to improve overall cool air flow and reduce the WBGT, the fan speed of one or more devices higher on a given rack may be reduced or maintained so as to reduce the amount of air flow into the face of the individual. As another example, in order to reduce the noise level at the location of the individual, the fan speed of one or more proximate computing devices may be reduced so as to reduce their overall noise output at the location of the individual.

In some embodiments, modifying 206 operation of the one or more computing devices may include redistributing 210 one or more workloads across the one or more computing devices. As an example, workloads executed on computing devices nearest to the individual may be offloaded to other computing devices further from the individual. Continuing with this example, workloads may be redistributed in a gradient fashion whereby fewer workloads, including no workloads, may be executed on the computing devices closest to the individual with increasing workload activity being distributed on computing devices as their distance to the individual increases. By reducing the workload activity on computing devices closest to the individual, these closer devices will necessarily produce less heat, thereby reducing the WBGT at the location of the individual.

Readers will appreciate that, in some embodiments, modifying 208 the fan speed of the one or more computing devices and redistributing 210 the workloads across the one or more computing devices may be used in combination depending on the particular environmental parameters to be modified. As an example, to reduce the WBGT and/or contact temperature at the location of the individual, workloads may be distributed further from the individual so as to reduce overall heat output while increasing the fan speed at proximate computing devices to improve cool air flow. In some embodiments, redistributing 210 the workloads may necessitate increasing the fan speed at computing devices experiencing higher workloads due to the increased heat production at those devices. As another example, to reduce the WBGT and/or contact temperature as well as the noise level at the location, workloads may be distributed further from the individual to reduce overall heat output, which may allow for fan speeds at closer devices to be reduced due to their reduced heat output, thereby also reducing the noise level at that location.

In some embodiments, modifying 204 the one or more environmental parameters at the location may be based on one or more environmental parameter targets. In some embodiments, the one or more environmental parameter targets may indicate, for example, a desired or preferred range of a particular operational parameter (e.g., a range of WBGTs) for an individual to experience. In some embodiments, the one or more environmental parameter targets may include a threshold value defining a safe or preferred level of a particular environmental parameter (e.g., a safe operating noise level, a safe WBGT level, a safe contact temperature). In some embodiments, the one or more environmental parameter targets may be user defined. In some embodiments, the one or more environmental parameter targets may correspond to various regulatory or safety requirements, such as standards or best practices outlined by the Occupational Safety and Health Administration (OSHA). In some embodiments, modifying 204 the one or more environmental parameters may include modifying 204 the one or more environmental parameters until a particular environmental parameter target is satisfied, or to reduce the differential between a current environmental parameter and the corresponding environmental parameter target. For example, the WBGT may be lowered until it falls below some threshold amount or falls within some range of WBGTs. As another example, the noise level may be reduced until it falls below some threshold amount.

Accordingly, in some embodiments, a particular environmental parameter at the location of the individual must be measured or estimated in order to determine whether a particular environmental parameter target has been satisfied. In some embodiments, one or more sensors may be housed in the data center, such as in the computing devices themselves, in the racks, or in other areas of the data center. Such sensors may include decibel meters, temperature sensors, and the like. As is set forth above, in some embodiments, a user device may include such sensors. Accordingly, such sensors may measure and provide readings of environmental parameters so as to determine of the particular environmental parameter targets have been satisfied. In some embodiments, thermal imaging may be used to measure or estimate temperature readings at a particular location and/or particular surface. In some embodiments, one or more trained models may be used to estimate environmental parameter targets based on performance metrics received from the computing devices of the data center, including processing (e.g., workload) activity, fan speed, and the like.

Existing solutions for controlling the environmental parameters of a data center may be inadequate in addressing both optimal working conditions and sustainability goals. For example, to address noise levels, an individual may be provided with hearing protection to wear while in the data center. However, this may result in the individual wearing hearing protection when not needed or may result in the individual wearing inadequate or improperly fit hearing protection. As another example, to address temperature concerns, fan speeds and/or computer room air conditioning (CRAC) systems may be run to constantly maintain safe or optimal WBGTs and/or contact temperatures, but this results in a significant energy expenditure that may be contrary to sustainability or energy usage goals. Instead, the approaches set forth above allow for variable control of environmental parameters based on the particular location of the individual in the data center. This ensures that the user is subject to the desired levels of various environmental parameters at their particular location without excessive energy usage.

Although the approaches set forth above describe modifying 204 environmental parameters at the location of an individual, readers will appreciate that, in some embodiments, the environmental parameters may also be modified 204 in response to not detecting any individuals in the data center. For example, where no individual is identified in the data center, workloads may be redistributed in a computationally optimal fashion independent of the particular locations of the computing devices executing those workloads and without consideration of the resulting noise levels. As another example, fan speeds or other temperature controls may be modulated to use a minimum amount of energy while keeping the computing devices within their operational temperature specifications.

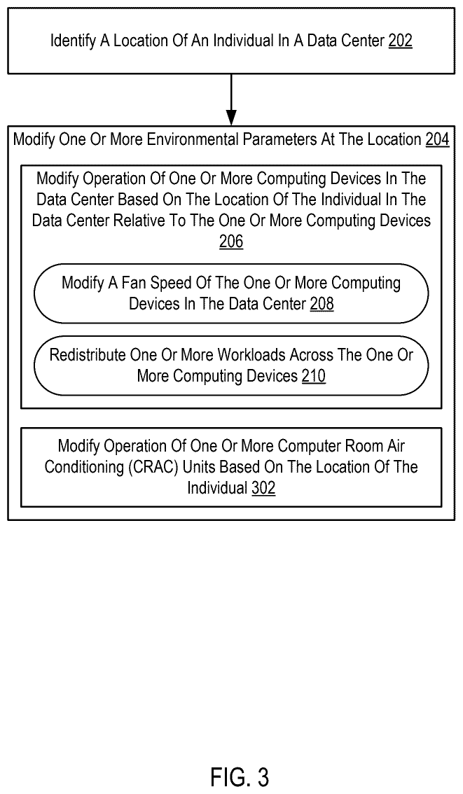

For further explanation, FIG. 3 sets forth a flowchart of another example method of automated on-demand occupant environment modulation in a data center in accordance with some embodiments of the present disclosure. The method of FIG. 3 is similar to FIG. 2 in that the method of FIG. 3 also includes: identifying 202 a location of an individual in a data center; and modifying 204 one or more environmental parameters at the location by modifying 206 operation of one or more computing devices in the data center based on the location of the individual in the data center relative to the one or more computing devices, including: modifying 208 a fan speed of the one or more computing devices in the data center; and redistributing 210 one or more workloads across the one or more computing devices.

The method of FIG. 3 differs from FIG. 2 in that modifying 204 one or more environmental parameters at the location also includes modifying 302 operation of one or more computer room air conditioning (CRAC) units based on the location of the individual. The one or more CRAC units serve to regulate the temperature and humidity in the data center. In some embodiments, the one or more CRAC units may each service particular subsections or areas of the data center, such as particular rows, particular aisles, and the like. Accordingly, in some embodiments, modifying 302 operation of one or more CRAC units based on the location of the individual may include increasing cool air flow from the one or more CRAC units. For example, CRAC units servicing an aisle (e.g., a hot aisle) where the individual is located may increase their cool air flow to reduce the WBGT of that aisle. As another example, CRAC units at adjacent cold aisles may increase cool air flow, thereby increasing the amount of cold air moving from the cold aisles to the hot aisles. As a further example, such as where workloads are migrated to computing devices further from the individual, CRAC units proximate to those computing devices may increase their cool air flow to account for the increased heat output from those computing devices.

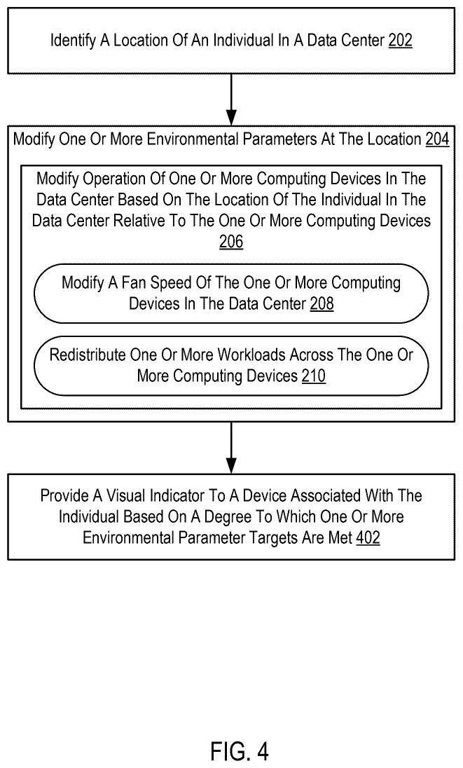

For further explanation, FIG. 4 sets forth a flowchart of another example method of automated on-demand occupant environment modulation in a data center in accordance with some embodiments of the present disclosure. The method of FIG. 4 is similar to FIG. 2 in that the method of FIG. 4 also includes: identifying 202 a location of an individual in a data center; and modifying 204 one or more environmental parameters at the location by modifying 206 operation of one or more computing devices in the data center based on the location of the individual in the data center relative to the one or more computing devices, including: modifying 208 a fan speed of the one or more computing devices in the data center; and redistributing 210 one or more workloads across the one or more computing devices.

The method of FIG. 4 differs from FIG. 2 in that the method of FIG. 4 also includes providing 402 a visual indicator to a device associated with the individual based on a degree to which the one or more environmental parameter targets are met. In some embodiments, the device may include a mobile device in possession of the individual or otherwise associated with the individual, such as a smartphone, tablet, laptop, and the like. In some embodiments, the device may include a sensor such as a wearable decibel meter or other wearable sensor as can be appreciated. The visual indicator may include a variety of visual indicators which may vary depending on the particular device to which the visual indicator is provided. For example, the visual indicator may include a notification, a message, a colored light, and the like. Accordingly, in some embodiments, providing 402 the visual indicator to the device may include providing a command or signal that may cause the device to display or present the visual indicator (e.g., to the individual).

As an example, in some embodiments, the visual indicator may serve as a binary indication as to whether a particular environmental parameter target is or is not met. Continuing with this example, the visual indicator may include a green light where the environmental parameter target is met and a red light where the environmental parameter target is not met. As another example, in some embodiments, the visual indicator may serve to indicate that a particular environmental target is met but not sustainable. Continuing with this example, assume that fan speeds at a particular device have been reduced so as to reduce the noise level below some threshold. Further assume that, though the noise level is below the threshold, the device may be unable to sustain operation using the reduced fan speeds for a prolonged period of time. In such an example, a yellow light may indicate that the environmental parameter target has been satisfied but cannot be maintained.

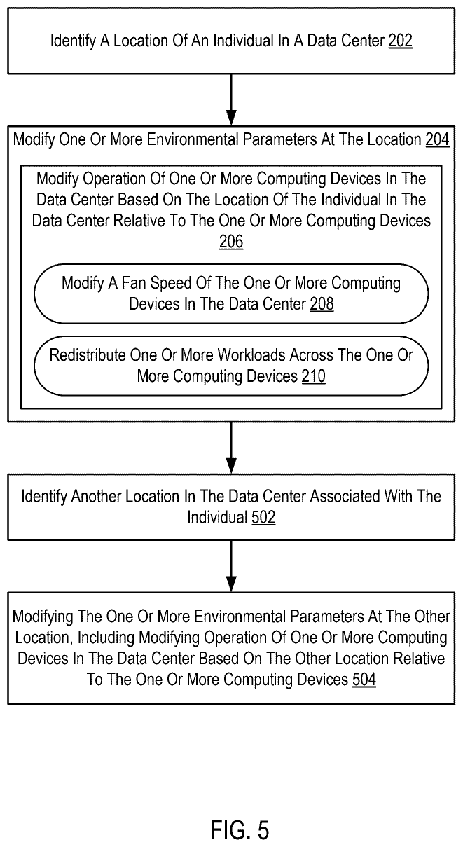

For further explanation, FIG. 5 sets forth a flowchart of another example method of automated on-demand occupant environment modulation in a data center in accordance with some embodiments of the present disclosure. The method of FIG. 5 is similar to FIG. 2 in that the method of FIG. 5 also includes: identifying 202 a location of an individual in a data center; and modifying 204 one or more environmental parameters at the location by modifying 206 operation of one or more computing devices in the data center based on the location of the individual in the data center relative to the one or more computing devices, including: modifying 208 a fan speed of the one or more computing devices in the data center; and redistributing 210 one or more workloads across the one or more computing devices.

The method of FIG. 5 differs from FIG. 2 in that the method of FIG. 5 also includes identifying 502 another location in the data center associated with the individual. In some embodiments, the other location may include an updated location of the individual, such as when the individual has moved from the previously identified 202 location. In such embodiments, the updated location of the individual may be identified using similar approaches as are described above. In some embodiments, the other location may include a predicted location of the individual. The predicted location of the individual is a location in the data center where the individual is predicted to be in some future time. The predicted location of the individual may be predicted using various approaches. For example, in some embodiments, movement of the individual may be monitored in order to predict a destination of the individual, such as another device to be serviced by the individual. In some embodiments, designated service schedules, ticketing systems, or other systems indicating particular devices to be serviced may be used to identify, as the destination of the individual, another device to be serviced. In some embodiments, performance logs may be used to identify devices experiencing degraded performance or other issues that may require service so as to predict, as the destination of the individual, another device to be serviced.

The method of FIG. 5 also includes modifying 504 the one or more environmental parameters at the other location, including modifying operation of one or more computing devices in the data center based on the other location relative to the one or more computing devices. Modifying 504 the one or more environmental parameters at the other location may be performed using any of the approaches set forth above with respect to modifying 204 the one or more environmental parameters at the location. Thus, the environmental parameters at an updated or predicted location of the individual may be modified so as to conform with various environmental parameter targets. Readers will appreciate that, in some embodiments, operation of other computing devices proximate to the previously identified 202 location may also be modified. For example, where the fan speeds at that location was increased to increase cooling or reduced to reduce noise, their fan speeds may be restored to their prior levels as the individual is no longer at that location. As another example, where workloads were migrated away from that location, some amount of workload may be redistributed to those computing devices as the individual is no longer at that location.

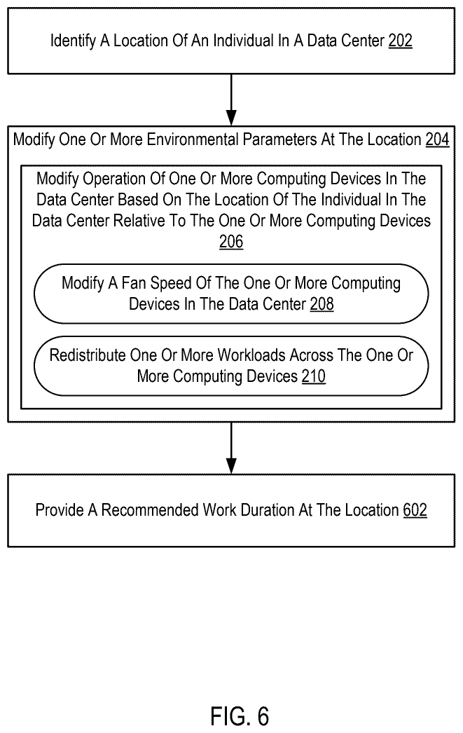

For further explanation, FIG. 6 sets forth a flowchart of another example method of automated on-demand occupant environment modulation in a data center in accordance with some embodiments of the present disclosure. The method of FIG. 6 is similar to FIG. 2 in that the method of FIG. 6 also includes: identifying 202 a location of an individual in a data center; and modifying 204 one or more environmental parameters at the location by modifying 206 operation of one or more computing devices in the data center based on the location of the individual in the data center relative to the one or more computing devices, including: modifying 208 a fan speed of the one or more computing devices in the data center; and redistributing 210 one or more workloads across the one or more computing devices.

The method of FIG. 6 differs from FIG. 2 in that the method of FIG. 6 also includes providing 602 a recommended work duration at the location. In some embodiments, providing 602 the recommendation may include providing the recommendation to a device associated with the individual. Accordingly, in some embodiments, the recommendation may be embodied or encoded as a notification, a message, or other data as can be appreciated. The recommended work duration at the location may be based on current or predicted measurements of a particular environmental parameter at the location. The recommended work duration may be based on various policies, regulatory requirements, and the like. For example, a regulatory requirement may define a maximum amount of time an individual should work at a given WBGT or should be subjected to a given noise level. Accordingly, the recommendation may indicate, based on a current WBGT or noise level, a recommendation to perform work in an amount of time below this maximum time. As another example, where operation of the one or more computing devices has been modified so as to satisfy an environmental parameter target in a non-sustainable way, the recommendation may indicate, to the user, an amount of time that this modification can be sustained before being reverted. Continuing with this example, where fan speeds at the location have been reduced to lower noise but the affected computing devices cannot maintain operation at this fan speed for more than some amount of time, the recommendation may suggest that the user complete their work before this amount of time.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying, by a computing device operatively coupled to one or more computing devices in a data center, based on data from one or more sensors, a location of an individual in the data center; and
modifying, by the computing device, one or more environmental parameters at the location, including modifying operation of the one or more computing devices in the data center based on the location of the individual in the data center relative to the one or more computing devices.

2. The method of claim 1, wherein the one or more environmental parameters comprise a wet bulb global temperature (WBGT) for the individual.

3. The method of claim 1, wherein the one or more environmental parameters comprise a contact temperature for the one or more computing devices.

4. The method of claim 1, wherein modifying the operation of the one or more computing devices in the data center comprises redistributing one or more workloads across the one or more computing devices.

5. The method of claim 1, wherein modifying the operation of the one or more computing devices in the data center comprises modifying a fan speed of the one or more computing devices in the data center.

6. The method of claim 1, wherein modifying the one or more environmental parameters further comprises modifying operation of one or more computer room air conditioning (CRAC) units based on the location of the individual.

7. The method of claim 1, wherein the one or more environmental parameters comprise a noise level.

8. The method of claim 1, further comprising providing a visual indicator to a device associated with the individual based on a degree to which one or more environmental parameter targets are met.

9. The method of claim 8, wherein the device facilitates at least one of measuring the one or more environmental parameters or identifying the location of the individual.

10. The method of claim 1, further comprising:
identifying another location in the data center associated with the individual; and
modifying the one or more environmental parameters at the other location, including modifying operation of one or more computing devices in the data center based on the other location relative to the one or more computing devices.

11. The method of claim 10, wherein the other location comprises an updated location of the individual.

12. The method of claim 10, wherein the other location comprises a predicted location of the individual.

13. The method of claim 1, further comprising providing a recommended work duration at the location.

14. An apparatus comprising:
a processing device; and
memory operatively coupled to the processing device, wherein the memory stores computer program instructions that, when executed, cause the processing device to:
identifying, based on data from one or more sensors, a location of an individual in the data center; and
modify one or more environmental parameters at the location, wherein, to modify the one or more environmental parameters, the instructions further cause the processing device to modify operation of one or more computing devices in the data center based on the location of the individual in the data center relative to the one or more computing devices.

15. The apparatus of claim 14, wherein the one or more environmental parameters comprise a wet bulb global temperature (WBGT) for the individual.

16. The apparatus of claim 14, wherein the one or more environmental parameters comprise a contact temperature for the one or more computing devices.

17. The apparatus of claim 14, wherein, to modify the operation of the one or more computing devices in the data center, the computer program instructions, when executed, further cause the processing device to redistribute one or more workloads across the one or more computing devices.

18. The apparatus of claim 14, wherein, to modify the operation of the one or more computing devices in the data center, the computer program instructions, when executed, further cause the processing device to modify a fan speed of the one or more computing devices in the data center.

19. The apparatus of claim 14, wherein, to modify the one or more environmental parameters, the instructions, when executed, further cause the processing device to modify operation of one or more computer room air conditioning (CRAC) units based on the location of the individual.

20. The apparatus of claim 14, wherein the one or more environmental parameters comprise a noise level.

21. The apparatus of claim 14, wherein the computer program instructions, when executed, further cause the processing device to provide a visual indicator to a device associated with the individual based on a degree to which one or more environmental parameter targets are met.

22. The apparatus of claim 21, wherein the device facilitates at least one of measuring the one or more environmental parameters or identifying the location of the individual.

23. The apparatus of claim 14, wherein the computer program instructions, when executed, further cause the processing device to:
identify another location in the data center associated with the individual; and
modify the one or more environmental parameters at the other location, wherein, to modify the one or more environmental parameters, the instructions further cause the processing device to modify operation of one or more computing devices in the data center based on the other location relative to the one or more computing devices.

24. The apparatus of claim 23, wherein the other location comprises an updated location of the individual.

25. A computer program product comprising a computer readable storage medium, wherein the computer readable storage medium comprises computer program instructions that, when executed:
identifying, by a computing device operatively coupled to one or more computing devices in a data center, based on data from one or more sensors, a location of an individual in the data center; and
modify one or more environmental parameters at the location, wherein, to modify the one or more environmental parameters, the instructions further cause the processing device to modify operation of one or more computing devices in the data center based on the location of the individual in the data center relative to the one or more computing devices.
